(19) United States
(12) Patent Application Publication
(10) Pub. No.: US 2020/0067213 A1
(43) Pub. Date: Feb. 27, 2020

(54) TERMINAL CONNECTOR AND METHOD FOR PRODUCING A TERMINAL CONNECTOR

(71) Applicant: Phoenix Contact GmbH & Co. KG, Blomberg (DE)

(72) Inventor: Daniel Utermöhle, Uslar (DE)

(21) Appl. No.: 16/344,097

(22) PCT Filed: Nov. 10, 2017
(86) PCT No.: PCT/EP2017/078882

§ 371 Date: Apr. 23, 2019

(30) Foreign Application Priority Data
Nov. 18, 2016 (DE) 10 2016 122 263.1

(51) Int. Cl. H01R 9/24; H01R 9/26

(52) U.S. Cl. CPC H01R 9/2466; H01R 9/26; H01R 9/2491

(57) ABSTRACT

The disclosure relates to a terminal connector for connecting one or more spring connections of a plug connector to one or more contact connections of an interface module. The terminal connector may include a printed circuit board including a lower side, an upper side, and one or more strip conductors, where each strip conductor of the one or more strip conductors is configured to be electrically connected to a contact connection of the one or more contact connections of the interface module. The terminal connector may also include one or more metal pins, where each metal pin of the one or more metal pins is connected, in an electrically conductive and integrally bonded manner, to a strip conductor of the one or more strip conductors of the printed circuit board, where the one or more metal pins extends from the lower side of the printed circuit board.

### CROSS-REFERENCE TO RELATED APPLICATIONS

This application is a 371 national phase filing of International Application No. PCT/EP2017/078882, entitled “TERMINAL CONNECTOR AND METHOD FOR PRODUCING A TERMINAL CONNECTOR”, filed 10 Nov. 2017, which claims priority to German Patent Application No. 10 2016 122 263.1, entitled “RANGIERVERBINDER UND VERFAHREN ZUM HERSTELLEN EINES RANGIERVERBINDERS”, filed 18 Nov. 2016.

### BACKGROUND

### Technical Field of the Invention

The present disclosure relates to a terminal connector for signal routing and a method for producing a terminal connector.

### TECHNICAL BACKGROUND OF THE INVENTION

In technical fields such as automation technology, a plurality of conductors are used in the signal-related connecting of control devices or systems such as programmable logic controllers (PLC) to respective field devices which may comprise sensors or actuators in order to convey signals to the desired location for controlling the respective devices and for evaluation purposes. The routing of signals via the wiring of conductors is thereby of great importance. The use of so-called terminal strips or connecting terminals in which signals are connected by single-lead routing, thus a wiring of individual conductors, is for example common in the prior art for signal connectivity between control devices and field devices. The term terminal connector or terminal board is also common for special examples of terminal strips or connecting terminals, in particular an array of centralized connecting terminals.

A further option for connecting signals between a control system and a field device also known from the prior art is for example that of connecting a control system signal via a prefabricated system cable using a so-called transmission module. A standard plug connector, e.g. of flat-ribbon cable (FLK) or D-Subminiature (SUB) type, is generally provided at a contact connection of a transmission or interface module which is connected on the output end by way of a printed circuit board to a spring connection such as e.g. a screw tension spring or a so-called push-in connecting terminal. The respective field signal is thereby connected to said connecting terminal. An example of a connecting terminal is provided in FIG. 1 and an example of a transmission module is described in the EP 2 1 15 539 B1 printed publication.

Particularly in the case of a plurality of signals and when using a corresponding number of single-lead wirings for the signal-related connecting of the respective systems and devices, it is of great importance to ensure a clear signal assignment with regard to the plurality of single-lead wirings or conductors utilized and the respective connecting terminals. In practice, the signal assignment of the connecting terminals generally occurs based on a specific imprinting of the terminals. At the same time, however, particularly in automation technology, one strives to implement a large number of single-lead wirings in the smallest possible available space; the packing density when wiring individual leads and conductors thus steadily increasing. Particularly when employing a large number of single-lead wirings, it has to date been a technical challenge and also only possible with great effort to concurrently realize clear and simple signal connectivity or signal routing respectively between a control system and one or more field devices alongside the aspired increased component packing density.

### SUMMARY

It is thus the task of the present disclosure to provide an improved terminal connector and a method for producing a terminal connector so as to enable a simple, flexible and economical approach to the signal connectivity or respectively signal routing between devices to be connected together in terms of their signals. A further task is additionally that of achieving a high packing density relative to the signal routing, or wiring of individual conductors respectively, and concurrently enabling clear signal separation and signal assignment.

The disclosure solves this task by the features of the independent claims. Advantageous examples of the present disclosure constitute the subject matter of the dependent claims, the description and the figures.

According to a first aspect, the disclosure relates to a terminal connector for connecting a number of spring connections of a plug connector to the number of contact connections of an interface module having a printed circuit board with a lower side and an upper side as well as a number of strip conductors, wherein each strip conductor is electrically connectable to a contact connection of the interface module; and a number of metal pins, wherein each metal pin is connected to a strip conductor of the printed circuit board in electrically conductive and integrally bonded manner, wherein the metal pins extend from the lower side of the printed circuit board and are insertable into the spring connections of the plug connector.

The terminal connector according to the disclosure achieves the advantage of obtaining higher signal routing flexibility as the number of centralized connecting terminals or terminal strips can be selected or expanded at will. Only the dimension of the printed circuit board needs to be accordingly adapted to the desired signal routing.

A further advantage is the cost savings since using the printed circuit board allows doing away with complex single-lead wiring and the process of producing the terminal connector with the relevant signal routing is considerably simplified and shortened.

A further advantage consists of the inventive terminal connector enabling explicit and simple signal separation and signal assignment since a large part of the otherwise customary single-lead wiring for signal routing becomes redundant.

An additional further advantage is, due to the printed circuit board and the electrically conductive and concurrent integral bonding of the metal pin to the printed circuit board, the inventive terminal connector is of sturdy design and thereby highly resistant to adverse external forces such as occur for example upon impacts or due to climatic influences.

According to one example of the present disclosure, the terminal connector comprises an interface contact arranged on the upper side of the printed circuit board, whereby the strip conductors of the printed circuit board are electrically connected, in particular electrically connected and integrally bonded, to the contact connections of the interface module. This thereby achieves the advantage of the terminal connector being sturdy and resistant to external forces acting on the terminal connector such as impacts or climatic influences such as heat or humidity.

According to one example of the present disclosure, the strip conductors run along the upper side of the printed circuit board or along the upper side and in at least one interlayer of the printed circuit board. This thus achieves the advantage of a strip conductor or signal crossing respectively being possible by virtue of a so-called multilayer arrangement without this causing an occurrence of electrical short circuits.

According to one example of the present disclosure, the interface module is an FLK connector, an insulation-displacement contact (IDC) connector, a D-SUB connector or an ELCO connector. This thereby allows the advantage of greater flexibility in the selection and use of different types of connectors in order for the inventive terminal connector and applicable interface module to be able to be used for many various technical fields of application.

According to one example of the present disclosure, a drill hole which extends at least to a strip conductor and/or cuts through a strip conductor is provided in the lower side of the printed circuit board for each metal pin and whereby each metal pin inserts into the corresponding drill hole. The drill hole simultaneously gives the metal pin a guide, which lends it additional support. Furthermore, the metal pin is more easily inserted by virtue of the respective drill hole. Automated connecting of the metal pin to the printed circuit board, for example by an appropriate mechanism, can additionally be realized particularly efficiently.

According to one example of the present disclosure, each metal pin exhibits a base section able to be inserted into a spring connection as well as a strip conductor section which contacts a strip conductor, wherein the strip conductor section is angled relative to the base section. This thereby achieves the advantage of the metal pin being able to be inserted into the spring connection more easily. Additionally thereby achieved is the metal pin being given a particularly secure holding and not being easily displaceable out of its position. Furthermore, the drill hole diameter of the individual drill holes on the printed circuit board can be minimized.

According to one example of the present disclosure, the strip conductor section is angled relative to the base section within an angular range of from 10° to 20°, in particular by 15°. This thereby achieves the advantage of being able to minimize the diameter for each respective drill hole on the printed circuit board, which results in particularly efficient utilization of the available printed circuit board surface. Moreover, a large number of drill holes enables efficiently producing a particularly sturdy and compact terminal connector.

According to one example of the present disclosure, the base section of a metal pin exhibits a larger diameter than the strip conductor section. This thereby achieves the advantage of obtaining uniform distances from the terminal connector. A more efficient connecting process for connecting the metal pin to the printed circuit board is thereby also enabled.

According to one example of the present disclosure, the base sections are disposed at an angle relative to the lower side. This thereby achieves the advantage of the base sections being able to be of particularly efficient design so as to be able to, for example, minimize the respective drill holes on the printed circuit board.

According to one example of the present disclosure, the metal pins exhibit a round or a quadrangular cross section. A quadrangular metal pin cross section in particular provides a larger bearing surface for the respective metal pins. This thereby enables preventing or at least minimizing a slipping or shifting of the metal pins.

According to one example of the present disclosure, the upper side of the printed circuit board is covered by a touch guard plate. This thereby achieves the advantage of preventing or at least minimizing external climatic influences or other acting material from contaminating or damaging the printed circuit board and portions of the metal pins or respectively the contact connections between the printed circuit board and the metal pins.

According to one example of the present disclosure, the touch guard plate is spaced from the upper side of the printed circuit board by means of spacers arranged laterally on the printed circuit board's upper side. This thereby achieves the advantage of possible irregularities at the contact connections between printed circuit board and metal pin, as can for example occur from localized protuberances due to accumulated soldering material, having no influence on the arrangement and thus the secure hold and shock resistance of the touch guard plate as far as the arrangement of said touch guard plate is concerned.

According to one example of the present disclosure, the plug connector is a strip terminal connector. This thereby achieves the advantage of simple and flexible expansion in terms of line and signal connections so that the plug connector can be flexibly adapted according to application requirements and field of application.

According to one example of the present disclosure, the spring connections of the plug connector as well as the metal pins have the same geometric configuration so that the metal pins can be concurrently inserted into the spring connections. This thereby achieves the advantage of only needing a relatively minimal force to insert the metal pins into the spring connections. The metal pins can as a result be inserted into the spring connections efficiently and quickly.

According to a second aspect, the disclosure relates to a plug connector assembly comprising a plug connector, in particular a strip connector, having a number of spring connections; and a terminal connector as per the first aspect, whereby the metal pins of the terminal connector are inserted into the spring connections and held in said spring connections by force. This thereby achieves the advantage of being able to realize a stable connection between the metal pins and the terminal connector in a particularly simple and also economical way without any additional clamping means being needed to make said connection.

According to a third aspect, the disclosure relates to a method for producing a terminal connector for connecting a number of spring connections of a plug connector to the number of contact connections of an interface module, said method comprising the providing of a printed circuit board having a lower side and an upper side as well as a number of strip conductors, wherein each strip conductor is electrically assigned a contact terminal of the interface module; and integrally bonding the number of metal pins to the number of strip conductors in order to connect each metal pin to a strip conductor, in particular to exactly one strip conductor, of the printed circuit board in an electrically conductive and integrally bonded manner, wherein the metal pins extend from the lower side of the printed circuit board and are insertable into the spring connections of the plug connector. The inventive method achieves the advantage of being able to easily produce a terminal connector which is sturdy and flexibly adaptable to different areas of application. Additionally, the inventive method enables a terminal connector of high packing density to be produced particularly efficiently and economically, particularly in an automated production process. Moreover, a clear and simple signal assignment or signal routing respectively can be realized in a particularly efficient manner.

According to one example of the present disclosure, the inventive method comprises the further steps of forming drill holes in the printed circuit board, wherein one drill hole is provided for one respective metal pin; inserting the metal pins into the drill holes; and integrally bonding the metal pins subsequent to the metal pins being inserted into the drill holes. These method steps can be realized efficiently, particularly when utilizing appropriate automation means. The integral bonding achieves the advantage of the printed circuit board being sturdy and firmly connected to the terminal connector and being particularly resistant, for example to impacts from outside.

### BRIEF DESCRIPTION OF THE DRAWINGS

Further examples will be described in greater detail with reference to the accompanying figures.

FIG. 1 shows a schematic sectional illustration of a terminal connector in side view comprising a printed circuit board and a metal pin connected to the printed circuit board according to one example of the present disclosure;

FIG. 2 shows a schematic illustration of a metal pin according to one example of the present disclosure; and

FIG. 3 shows a diagram of a method for producing a terminal connector.

### DETAILED DESCRIPTION

The following detailed description makes reference to the accompanying drawings, which form a part hereof and in which specific examples for implementing the disclosure are shown by way of illustration. It is understood that other examples may also be utilized and structural or logical changes may be made without departing from the concept of the present disclosure. The following detailed description is therefore not to be understood in a limiting sense. It is further understood that unless specifically stated otherwise, the features of the various examples described herein can be combined with one another.

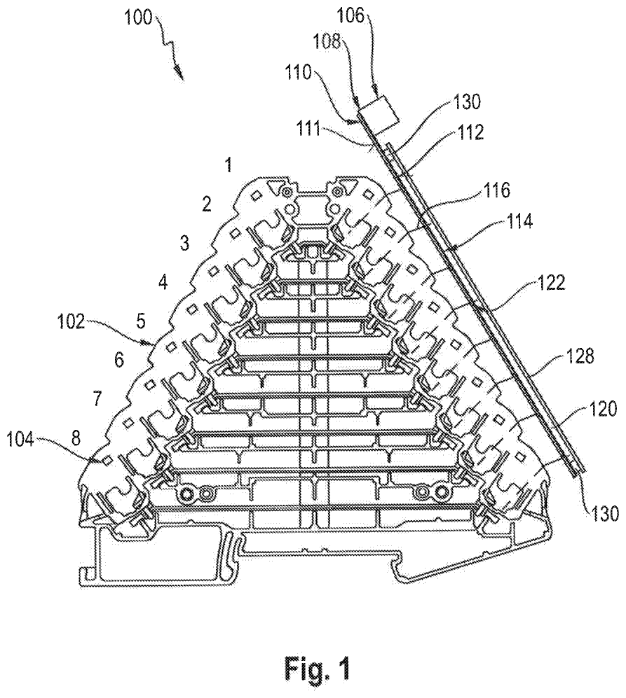

FIG. 1 shows a schematic sectional illustration of a terminal connector 100 in side view and comprising an attached printed circuit board 110 and a plug connector 102 according to one example of the present disclosure; the terminal connector 100 for connecting a number of spring connections 104 of the plug connector 102 to the number of contact connections 108 of an interface module 106. The following will reference the terminal connector 100 depicted in FIG. 1.

According to FIG. 1, the terminal connector 100 comprises a printed circuit board 110 having a lower side Ill and an upper side 112 as well as a number of strip conductors 114, wherein each strip conductor 114 is electrically connectable to a contact connection 108 of the interface module 106. Each of the metal pins 116 depicted in FIG. 1 are connected to a strip conductor 114 of the printed circuit board 110 in electrically conductive and integrally bonded manner. The metal pins 116 thereby extend from the lower side 11 of the printed circuit board 110 and are insertable into the spring connections 104 of the plug connector 102.

According to FIG. 1, the interface contact 108 is preferably arranged on the upper side 112 of the printed circuit board 110. The strip conductors 114 of the printed circuit board 110 are thereby electrically connected, in particular electrically connected and integrally bonded, to the contact connections 108 of the interface module 106. The interface module 106 can thereby be designed as an FLK connector, an IDC connector, a D-SUB connector or an ELCO connector.

According to one example, the strip conductors 114 run along the upper side 112 of the printed circuit board 110 or along the upper side and in at least one interlayer 120 of the printed circuit board 110.

As FIG. 1 shows, a drill hole 122 is provided in the lower side Ill of the printed circuit board 110 for the metal pin 116 which extends to at least to a strip conductor 114 and cuts through a strip conductor 114 and whereby the metal pin 116 is inserted into the drill hole 122.

In the terminal connector 100 depicted in FIG. 1, the upper side 112 of the printed circuit board 110 is covered by a touch guard plate 128. This preferably serves in protecting the printed circuit board from impurities or damages by external influences such as high or low temperatures or liquids which could damage a respective cohesive contact connection between the printed circuit board 110 and a metal pin 116. The touch guard plate 128 is spaced at a distance from the upper side 112 of the printed circuit board 110 by means of spacers 130. Said spacers 130 are preferably arranged laterally on the upper side 112 of the printed circuit board 110. However, other positions are possible.

The plug connector 102 according to FIG. 1 can preferably be a strip terminal connector.

The spring connections 104 of the plug connector 102 as well as the metal pins 116 can preferably exhibit the same geometric configuration so that the metal pins 116 can be concurrently inserted into the spring connections 104.

The terminal connector 100 and the plug connector 102 may be a component part of a plug connector assembly (not depicted in FIGS. 1 to 3). The plug connector 102 can in particular be thereby designed as a strip connector having a number of spring connections 104 and the terminal connector 100 can exhibit metal pins 116, wherein the metal pins 116 of the terminal connector 100 are inserted into the spring connections 104 and held in said spring connections 104 by force.

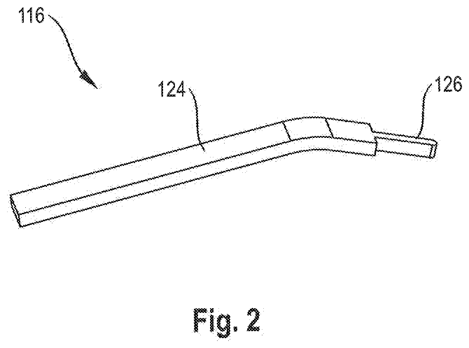

FIG. 2 shows a schematic illustration of a metal pin 116 according to one example of the present disclosure. The metal pin 116 according to FIG. 2 comprises a base section 124, which can be inserted into a spring connection 104 as suggested in FIG. 1, as well as a strip conductor section 126 which contacts a strip conductor 114, whereby the strip conductor section 126 is angled relative to the base section 124. The strip conductor section 126 is preferably angled relative to the base section 124 within an angular range of 10° to 20°, in particular 15°, which is of advantage in being able to produce smaller and thus space-saving drill holes. The base section 124 of a metal pin 116 preferably exhibits a larger diameter than the strip conductor section 126. The base sections 124 can furthermore be disposed at an angle relative to the lower side 111. The metal pins 116 can preferably exhibit a round or a quadrangular cross section. A quadrangular cross section is advantageous as it thereby allows providing a larger bearing surface for the respective metal pins 116. Doing so enables preventing or at least minimizing a slipping or shifting of the metal pins 116.

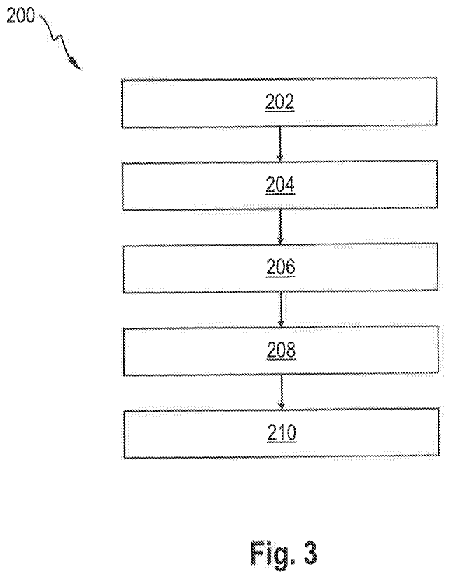

FIG. 3 shows a diagram of a method 200 for producing a terminal connector 100 for connecting a number of spring connections 104 of a plug connector 102 to the number of contact connections 108 of an interface module 106. The method 200 comprises a first step of providing 202 a printed circuit board 110 having a lower side 111 and an upper side 112 as well as a number of strip conductors 114, whereby each strip conductor 114 is electrically allocated to a contact terminal 108 of the interface module 106. The method 200 comprises a second step 204 of integrally bonding the number of metal pins 116 to the number of strip conductors 114 in order to connect each metal pin 116 to a strip conductor 114, in particular to exactly one strip conductor 114, of the printed circuit board 110 in an electrically conductive and integrally bonded manner, wherein the metal pins 116 extend from the lower side 111 of the printed circuit board 110 and are insertable into the spring connections 104 of the plug connector 102. The method 200 can additionally comprise a third step 206 of forming drill holes 122 in the printed circuit board 110, wherein one drill hole 122 is provided for one respective metal pin 116. The method 200 can comprise a fourth step 208 of inserting the metal pins into the drill holes 122. The method 200 can comprise a fifth step 210 of integrally bonding the metal pins 116 subsequent to the metal pins 116 being inserted into the drill holes 122.

The terminal connector 100 is designed to be producible by the above-cited method 200.

### LIST OF REFERENCE NUMBERS

100 terminal connector
102 plug connector
104 spring connection
106 interface module
108 contact connection/interface contact
110 printed circuit board
111 lower side of printed circuit board
112 upper side of printed circuit board
114 strip conductor
116 metal pin
120 interlayer
122 drill hole
124 base section
126 strip conductor section
128 touch guard plate
130 spacer
200 method
202 producing a terminal connector
204 integrally bonding the number of metal pins
206 forming drill holes
208 inserting the metal pins
210 integrally bonding the metal pins

What is claimed is:

1. A terminal connector for connecting one or more spring connections of a plug connector to of one or more contact connections of an interface module, comprising:
a printed circuit board comprising a lower side, an upper side, and one or more strip conductors, wherein each strip conductor of the one or more strip conductors is configured to be electrically connected to a contact connection of the one or more contact connections of the interface module;
one or more metal pins, wherein each metal pin of the one or more metal pins is connected, in an electrically conductive and integrally bonded manner, to a strip conductor of the one or more strip conductors of the printed circuit board, wherein the one or more metal pins extend from the lower side of the printed circuit board and are configured to be inserted into the one or more spring connections of the plug connector.

2. The terminal connector according to claim 1, further comprising:
an interface contact arranged on the upper side of the printed circuit board, wherein the one or more strip conductors of the printed circuit board are electrically connected and integrally bonded to the one or more contact connections of the interface module.

3. The terminal connector according to claim 1, wherein the one or more strip conductors run along the upper side of the printed circuit board, or along the upper side and in at least one interlayer of the printed circuit board.

4. The terminal connector according to claim 1, wherein the interface module is a flat-ribbon cable (FLK) connector, an insulation-displacement contact (IDC) connector, a D-Subminiature (SUB) connector or an ELCO connector.

5. The terminal connector according to claim 1, further comprising:
a drill hole formed in the lower side of the printed circuit board is configured for each metal pin of the one or more metal pins, wherein the drill hole extends at least to a strip conductor of the one or more strip conductors and/or or cuts through a strip conductor of the one or more strip conductors, and wherein each metal pin of the one or more metal pin is inserted into the corresponding drill hole.

6. The terminal connector according to claim 1, wherein each metal pin of the one or more metal pins comprises a base section configured to be inserted into a spring connection of the one or more strip connections and a strip conductor section that contacts a strip conductor of the one or more strip conductors, wherein the strip conductor section is angled relative to the base section.

7. The terminal connector according to claim 6, wherein the strip conductor section is angled relative to the base section within an angular range of 10 to 20°.

8. The terminal connector according to claim 6, wherein the base section of each metal pin of the one or more metal pins comprises a larger diameter than the strip conductor section.

9. The terminal connector according to claim 6, wherein the base section is disposed at an angle relative to the lower side.

10. The terminal connector according to claim 1, wherein the one or more metal pins comprise a round or a quadrangular cross section.

11. The terminal connector according to claim 1, wherein the upper side of the printed circuit board is covered by a touch guard plate.

12. The terminal connector according to claim 11, wherein the touch guard plate is separated from the upper side of the printed circuit board using spacers that are arranged laterally on the upper side of the printed circuit board.

13. The terminal connector according to claim 1, wherein the plug connector is a strip terminal connector.

14. The terminal connector according to claim 1, wherein the one or more spring connections of the plug connector and the metal pins the comprise a same geometric configuration, and the metal pins are configured to be concurrently inserted into the one or more spring connections.

15. A plug connector assembly, comprising:
a plug connector comprising one or more spring connections; and
a terminal connector comprising a printed circuit board with a lower side, an upper side, and one or more strip conductors, and one or more metal pins each connected to a strip conductor of the one or more strip conductors, wherein the one or more metal pins of the terminal connector are configured to be inserted into the one or more spring connections and held in the one or more spring connections by force.

16. A method for producing a terminal connector for connecting one or more spring connections of a plug connector to one or more contact connections of an interface module, comprising:
providing a printed circuit board comprising a lower side, an upper side, and one or more strip conductors, wherein each strip conductor of the one or more strip conductors is electrically assigned a contact terminal of the one or more contact terminals of the interface module; and
integrally bonding the one or more metal pins to the one or more strip conductors to connect, in an electrically conductive and integrally bonded manner, each metal pin of the one or more metal pins to a strip conductor of the one or more strip conductors of the printed circuit board, wherein the one or more metal pins extend from the lower side of the printed circuit board and are configured to be inserted into the one or more spring connections of the plug connector.

17. The method according to claim 16, further comprising:
forming one or more drill holes in the printed circuit board, wherein each drill hole of the one or more drill holes is provided for one respective metal pin;
inserting the one or more metal pins into the one or more drill holes; and
integrally bonding the one or more metal pins after the one or more metal pins are inserted into the one or more drill holes.

18. The terminal connector according to claim 7, wherein the strip conductor section is angled relative to the base section by 15°.

19. The plug connector assembly according to claim 15, wherein the plug connector comprises a strip connector.

20. The plug connector assembly according to claim 15, wherein each strip conductor of the one or more strip conductors is configured to be electrically connected to a contact connection of one or more contact connections of an interface module, and wherein the one or more metal pins extend from the lower side of the printed circuit board and are configured to be inserted into the one or more spring connections of the plug connector.
